(19) United States
(12) Patent Application Publication
(10) Pub. No.: US 2004/0252107 A1
(43) Pub. Date: Dec. 16, 2004

(54) Scrolling device for scrolling a two-dimensional window

(75) Inventors: Ming-Hsueh Tsai, Taoyuan (TW); Ching-Hung Lin, Taoyuan (TW)

Correspondence Address: QUINTERO LAW OFFICE, 1617 BROADWAY, 3RD FLOOR, SANTA MONICA, CA, 90404, US

(73) Assignee: BENQ Corporation

(21) Appl. No.: 10/822,536

(22) Filed: Apr. 12, 2004

(30) Foreign Application Priority Data
Apr. 14, 2003 (TW) 92108520

(51) Int. Cl. G09G 5/08

(52) U.S. Cl. 345/163; 345/156

(57) ABSTRACT

A scrolling device for scrolling a two-dimensional window having a first scroll and a second scroll is disclosed. The scrolling device has a flexible base, a scroll wheel rotatably connected to the flexible base, and a first switch positioned next to the flexible base. The first scroll of the window scrolls in a first direction when the scroll wheel is rotated. The first switch is turned on as the scroll wheel is forced to press the flexible base so as to scroll the second scroll of the window in a second direction.

### BACKGROUND OF THE INVENTION

1. Field of the Invention

The present invention relates to a scrolling device for scrolling a two-dimensional window.

2. Description of the Related Art

Typically, users interact with a computer by manipulating a pointing device, known as a mouse. The mouse moves a graphical object, known as a cursor or pointer, across a computer screen and to interact with icons or regions of the display. The user inputs a command to the mouse, generally referred to as a “click” to execute a given task or operation. In addition to a mouse, the cursor or pointer can be controlled by a variety of human-computer interface devices connected to the computer.

The mouse moves over a planar surface to control the cursor or pointer on the 2-dimensional computer display screen The pointer moves corresponding to position of the mouse on the planar surface. This is typically known as “position control,” where the motion of the graphical object is directly correspondent to the position of the mouse. A mouse may also have a plurality of “rate control” elemments, i.e. pressure-sensitive elements such as buttons, to perform functions not solely related to the planar position of the mouse. The user performs these functions, such as object selecting and dragging actions, by clicking a button on the mouse.

Further, a plurality of functions may relate to both position control and rate control, of which a “scrolling” action is an example. A “scroll wheel” or “mouse wheel” element is often included on a mouse to perform the scrolling action. The scroll wheel is conveniently disposed on the mouse, generally between two mouse buttons, and is rotated to control a scrolling or display zoom function. Generally, a portion of the scroll wheel protrudes out of the top surface of the mouse. The scroll wheel includes rubber or another frictional object to facilitate easy rotation by fingers. The scroll wheel is most commonly used to scroll a document or a graphic in a window without requiring use of the scroll bar element of the window, or to zoom in or out on the displayed contents without selecting a separate zoom control.

FIG. 1 shows a typical mouse. The mouse has a base 11 and a scroll wheel 12 rotatably connected to the base 11. To scroll a window vertically, the user rotates the scroll wheel 12 without dragging the vertical scroll bar of the window. However, the user needs to drag the horizontal scroll bar when scrolling the contents of a window horizontally. This may be an awkward movement, as the user must move the cursor to the horizontal scroll bar before performing the dragging action.

Accordingly, a “clicking” scroll wheel has been developed to control the horizontal scrolling action. When scrolling the window two-dimensionally, the user clicks down the scroll wheel. The position control of the mouse, i.e. the motion of the user manipulation, controls the position of the displayed content. That is, when the scroll wheel is clicked, the cursor is fixed on the screen, and the window scrolls corresponding to the user manipulation.

However, with this “clicking” scroll wheel, motion of the mouse controls either the cursor or the window scrolling. Specifically, it is impossible for a user to perform a complicated action, in which the window scrolls and the cursor moves simultaneously.

Accordingly, an object of the present invention is is to provide a scrolling device for scrolling a two-dimensional window, in which the scroll wheel can be utilized to scroll without being clicked.

The present invention discloses a scrolling device for scrolling the two-dimensional window. The window has a first scroll and a second scroll. The scrolling device has a flexible base, a scroll wheel rotatably connected to the flexible base, and a first switch positioned next to the flexible base. The first scroll of the window scrolls in a first direction when the scroll wheel is rotated. The first switch is turned on as the scroll wheel is forced to press the flexible base so as to scroll the second scroll of the window in a second direction.

In the scrolling device of the present invention, the first direction can be substantially perpendicular to the second direction. Further, the flexible base has a pedestal, a resilient device connected to the pedestal, and a holder connected to the resilient device and being supporting the scroll wheel.

The scrolling device of the present invention further comprises a first side board located next to the flexible base, and the first switch is disposed on the first side board. Alternatively, the scrolling device has a first side board located next to the flexible base, and positioned the first switch thereon, a second side board located next to the flexible base and opposite to the first side board, and a second switch disposed on the second side board. The second switch is turned on as the scroll wheel is forced to press the flexible base so as to scroll the second scroll of the window in a third direction, and the third direction is substantially opposite to the second direction.

Further, the scrolling device can be positioned in a mouse.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 illustrates a schematic view of a conventional mouse;

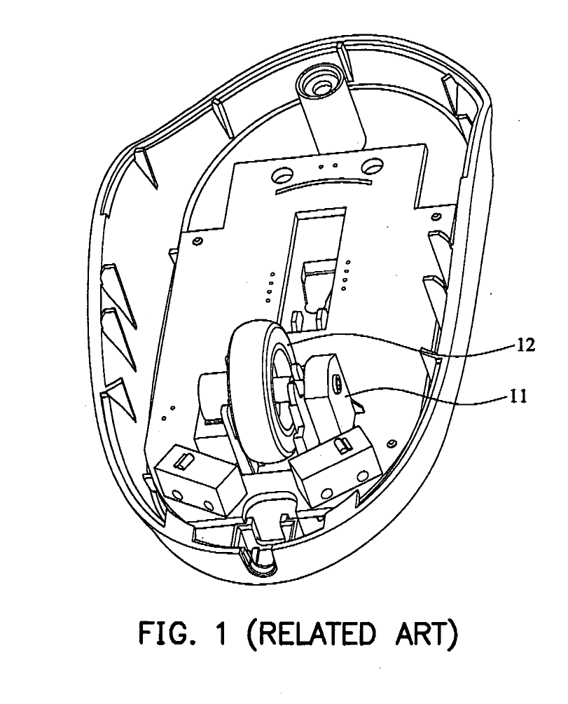

FIG. 2a is a perspective view showing an embodiment of a scrolling device for scrolling a two-dimensional window of the present invention; and

FIG. 3 is a cross-sectional view along the B-B′ line of FIG. 2a.

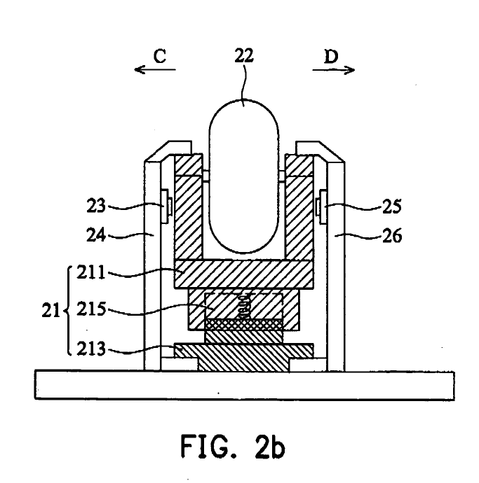

### DETAILED DESCRIPTION OF THE INVENTION

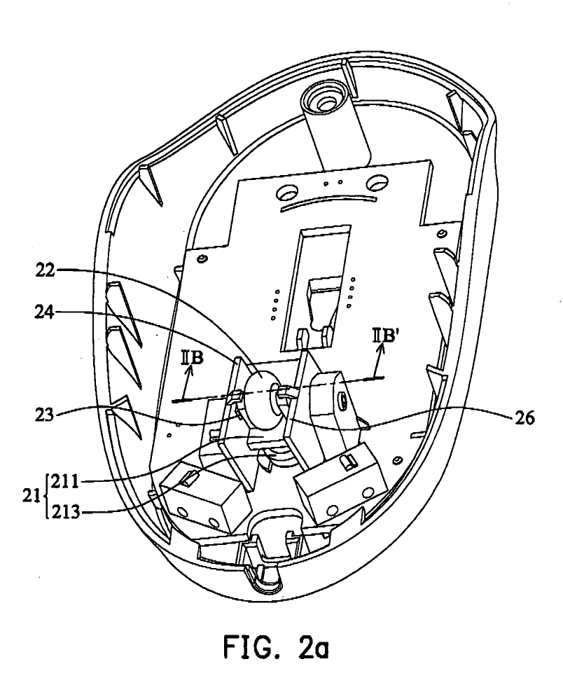

Disclosed hereinafter is a scrolling device for scrolling a two-dimensional window on a computer screen. The scrolling device can be positioned in a mouse. The window has a first scroll and a second scroll (not shown in the drawings). An embodiment of the scrolling device is described in detail with reference to FIG. 2a and FIG. 2b.

The scrolling device of the present invention has a flexible base 21, a scroll wheel 22 rotatably connected to the flexible base 21, and a first switch 23 positioned next to the flexible base 21.

Specifically, the flexible base 21 has a holder 211, a pedestal 213 and a resilient device 215. The holder 211 supports the scroll wheel 22 and the holder 211 is further connected to the resilient device 215. The resilient device 215, which can be a compressible spring, is connected to the pedestal 213 so that the scroll wheel 22 can be “clicked” as mentioned in the prior art.

In the embodiment of this invention, a first side board 24 and a second side board 26 are provided. The first side board 24 and the second side board 26 are positioned next to the flexible base 24 in the opposite position. A first switch 23 is disposed on the first side board 24, and a second switch 25 is disposed on the second side board 26.

The scroll wheel 22 can be rotated so that the first scroll of the window on the screen scrolls in a first direction, i.e. the vertical direction. That is, to scroll the window vertically, the user rotates the scroll wheel 22 to scroll the window vertically, as mentioned in the prior art.

Further, as shown in FIG. 2b, the first switch 23 is turned on as the scroll wheel 22 is forced to press the flexible base 21, so as to scroll the second scroll of the window in a second direction. The scroll wheel 22 is exerted by a force in direction C (the left arrow) and then deflected toward the first switch 23. The second switch 25 is turned on as the scroll wheel 22 is forced to press the flexible base 21 so as to scroll the second scroll of the window in a third direction. The third direction is substantially opposite to the second direction. At this time, the scroll wheel 22 is exerted by a force in direction D (the right arrow) and then deflected toward the second switch 25.

Specifically, to scroll the window horizontally, the user pushes the scroll wheel 22 left or right. When the user pushes the scroll wheel 22 left, a force along direction C is applied to the scroll wheel 22 to deflect the flexible base 21 toward the first switch 23, so that the first switch 23 is turned on and the second scroll (the horizontal scroll) of the window scrolls in the second direction (the horizontal direction), which is substantially perpendicular to the first direction (the vertical direction).

Otherwise, when the user pushes the scroll wheel 22 right, a force along direction D is applied to the scroll wheel 22 to deflect the flexible base 21 toward the second switch 25, so that the second switch 25 is turned on and the second scroll (the horizontal scroll) of the window scrolls in a third direction, which is opposite to the second direction (the horizontal direction).

Thus, with the scrolling device of the present invention, the two-dimensional window is easily scrolled without requiring scroll wheel clicking.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scrolling device for scrolling a two-dimensional window, the window having a first scroll and a second scroll, the scrolling device comprising:
a flexible base;
a scroll wheel rotatably connected to the flexible base, and the first scroll of the window scrolling in a first direction when the scroll wheel being rotating; and
a first switch positioned next to the flexible base,
wherein the first switch is turned on as the scroll wheel is forced to press the flexible base so as to scroll the second scroll of the window in a second direction.

2. The scrolling device as claimed in claim 1, wherein the first direction is substantially perpendicular to the second direction.

3. The scrolling device as claimed in claim 1, wherein the flexible base comprises:
a pedestal;
a resilient device connected to the pedestal; and
a holder connected to the resilient device and being supporting the scroll wheel.

4. The scrolling device as claimed in claim 1, further comprising a first side board located next to the flexible base, and the first switch being disposed on the first side board.

5. The scrolling device as claimed in claim 1, further comprising:
a first side board located next to the flexible base, and positioned the first switch thereon;
a second side board located next to the flexible base and opposite to the first side board; and
a second switch disposed on the second side board, wherein the second switch is turned on as the scroll wheel is forced to press the flexible base so as to scroll the second scroll of the window in a third direction, and the third direction is substantially opposite to the second direction.

6. The scrolling device as claimed in claim 1, wherein the scrolling device is positioned in a mouse.
